(19) United States
(12) Patent Application Publication
(10) Pub. No.: US 2026/0107345 A1
(43) Pub. Date: Apr. 16, 2026

(54) COMMUNICATION METHOD AND USER EQUIPMENT

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/419,636

(22) Filed: Dec. 15, 2025

Related U.S. Application Data
(63) Continuation of application No. PCT/JP2024/022147, filed on Jun. 19, 2024.

(30) Foreign Application Priority Data
Jun. 21, 2023 (JP) 2023-101435

(51) Int. Cl. H04W 76/40; H04W 76/27

(52) U.S. Cl. CPC H04W 76/40; H04W 76/27

(57) ABSTRACT

A communication method performed by a user equipment in a mobile communication system for providing a multicast/broadcast service (MBS) includes receiving, from a network, information for configuring a resume condition for initiating a radio resource control (RRC) connection resume at a time of multicast reception in an RRC inactive state, the resume condition being related to multicast reception quality, evaluating whether the multicast reception quality satisfies the resume condition when performing the multicast reception in the RRC inactive state, holding log information related to the multicast reception based on the multicast reception quality satisfying the resume condition, and transmitting the log information to the network after transitioning from the RRC inactive state to an RRC connected state.

### RELATED APPLICATIONS

The present application is a continuation based on PCT Application No. PCT/JP2024/022147, filed on Jun. 19, 2024, which claims the benefit of Japanese Patent Application No. 2023-101435 filed on Jun. 21, 2023. The content of which is incorporated by reference herein in their entirety.

### TECHNICAL FIELD

The present disclosure relates to a communication method and a user equipment used in a mobile communication system.

### BACKGROUND

The 3rd Generation Partnership Project (3GPP) (trademark, the same applies to the following descriptions) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1:3GPP Technical Specification: TS 38.300 V17.4.0

### SUMMARY

In a first aspect, a communication method is a communication method performed by a user equipment in a mobile communication system for providing a multicast/broadcast service (MBS), the communication method including the steps of receiving, from a network, information for configuring a resume condition for initiating a radio resource control (RRC) connection resume at a time of multicast reception in an RRC inactive state, the resume condition being related to multicast reception quality, evaluating whether the multicast reception quality satisfies the resume condition when performing the multicast reception in the RRC inactive state, holding log information related to the multicast reception based on the multicast reception quality satisfying the resume condition, and transmitting the log information to the network after transitioning from the RRC inactive state to an RRC connected state.

In a second aspect, a user equipment is a user equipment used in a mobile communication system for providing a multicast/broadcast service (MBS), the user equipment including a receiver configured to receive, from a network, information for configuring a resume condition for initiating a radio resource control (RRC) connection resume at a time of multicast reception in an RRC inactive state, the resume condition being related to multicast reception quality, a controller configured to evaluate whether the multicast reception quality satisfies the resume condition when performing the multicast reception in the RRC inactive state, and hold log information related to the multicast reception based on the multicast reception quality satisfying the resume condition, and a transmitter configured to transmit the log information to the network after transitioning from the RRC inactive state to an RRC connected state.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to an embodiment.

FIG. 3 is a diagram illustrating a configuration example of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an operation of the mobile communication system according to the embodiment.

FIG. 7 is a flowchart illustrating an example of a first operation pattern or a second operation pattern of the mobile communication system according to the embodiment.

FIG. 8 is a flowchart illustrating an example of a third operation pattern of the mobile communication system according to the embodiment.

FIG. 9 is a flowchart illustrating an example of a fourth operation pattern of the mobile communication system according to the embodiment.

### DESCRIPTION OF EMBODIMENTS

Currently, in 3GPP, a study is underway to extend the specifications such that a user equipment that performs multicast reception in an RRC inactive state initiates resuming an RRC connection when reception quality of multicast data deteriorates compared to a configured threshold. Accordingly, when quality of service (QoS) required for multicast reception is not satisfied, the user equipment can autonomously transition to the RRC connected state through the RRC connection resume, and thus the QoS required for multicast reception is easily satisfied.

However, in the current 3GPP technical specifications, the network cannot recognize the situation when the QoS required for multicast reception is not satisfied, and therefore, it is difficult to perform network optimization to keep such a situation from recurring. Therefore, the existing technology has room for improvement in terms of enabling improvement of the QoS of the MBS.

The present disclosure aims at enabling improvement of QoS of an MBS.

According to an embodiment, a mobile communication system is described with reference to the drawings. In the description of the drawings, the same or similar parts are denoted by the same or similar reference signs.

### (1) System Configuration Example

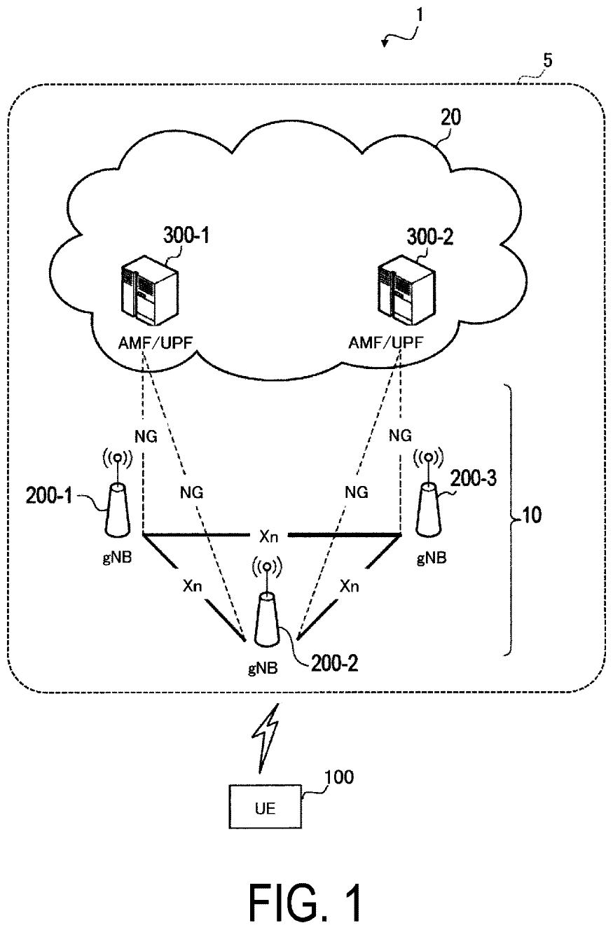

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

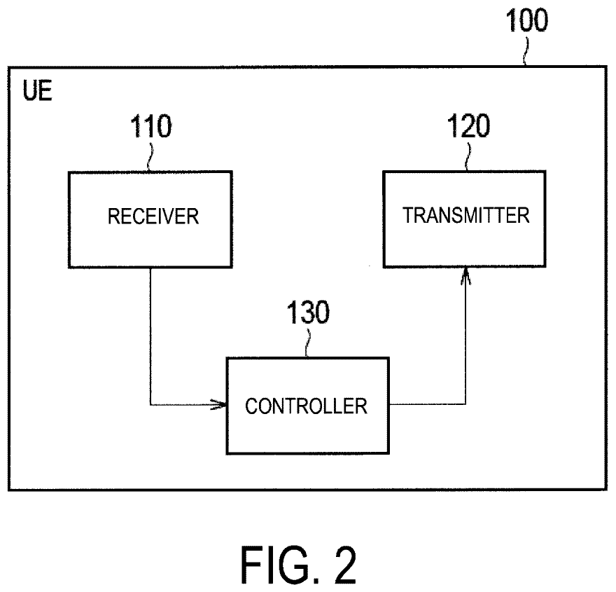

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

Note that the UE 100 may include a positioning unit, for example, a global navigation satellite system (GNSS) receiver for acquiring location information indicating a geographical location (latitude, longitude, and height) of the UE 100.

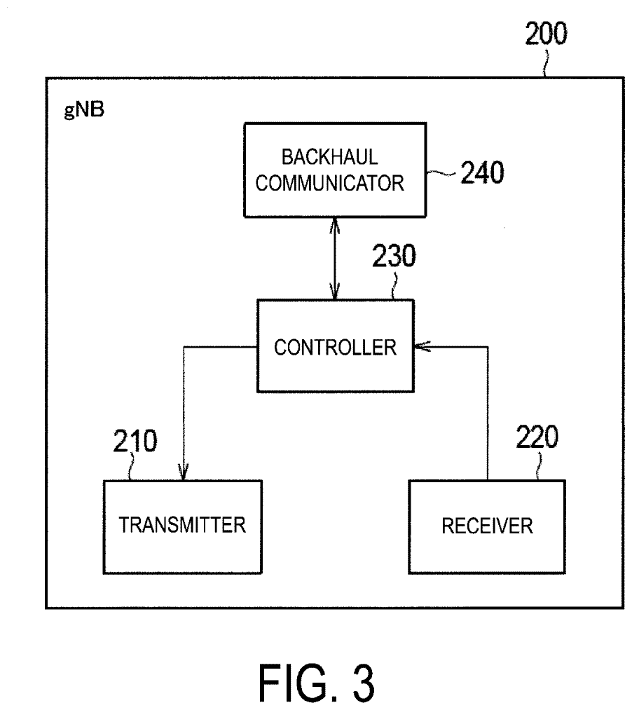

FIG. 3 is a diagram illustrating a configuration example of the gNB 200 (the base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

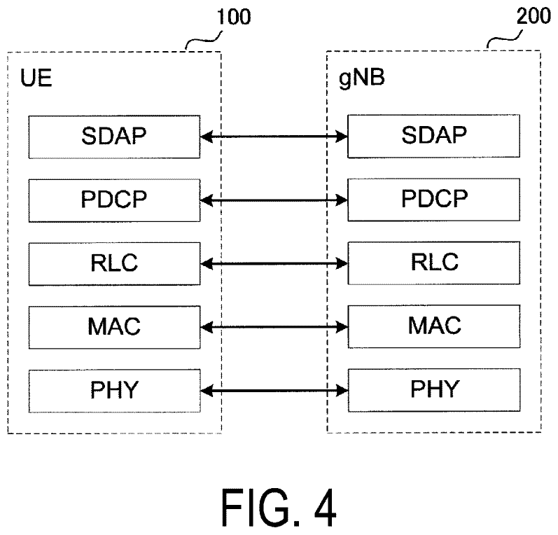

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. CRC parity bits scrambled by the RNTI are added to the DCI transmitted from the gNB 200.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

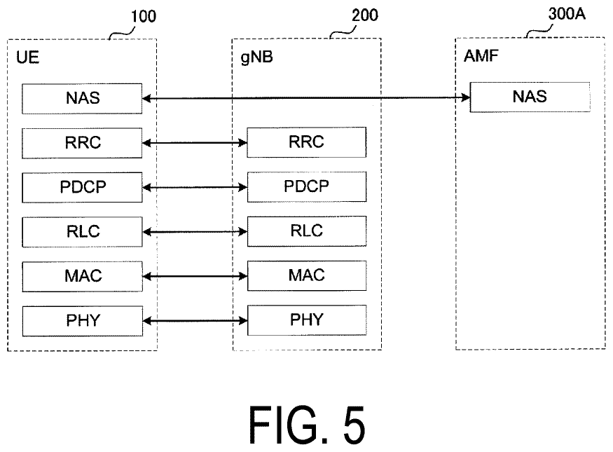

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state. Note that the MBS session is identified by an MBS session ID (e.g., Temporary Mobile Group Identity (TMGI)).

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 uses a group-common PDCCH with a cyclic redundancy code (CRC) scrambled by a group RNTI (G-RNTI) that is a group-common RNTI to schedule a group-common PDSCH scrambled by the G-RNTI.

For the broadcast communication service, the UE 100 receives a broadcast session in the following procedure. First, the UE 100 receives system information block type 20 (SIB20) from the gNB 200. The SIB20 includes a configuration of a multicast control channel (MCCH), which is a type of logical channel. Second, the UE 100 receives the MCCH from the gNB 200 based on the SIB20. The MCCH includes a PTM configuration. The PTM configuration carries a configuration for a multicast traffic channel (MTCH), which is a type of logical channel, and a configuration of a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (2.2.1) Multicast Reception in Rrc Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a dedicated control channel (DCCH). The RRC Reconfiguration message transmits a configuration for an MTCH for multicast session reception and a configuration of a multicast MRB which is an MRB for multicast session. Second, the UE 100 receives an MTCH based on the RRC Reconfiguration message. The MTCH transmits a multicast session (specifically, MBS data belonging to the multicast session). Note that the configuration for the MTCH (MTCH configuration) is a configuration for MTCH reception, and includes, for example, at least one selected from the group consisting of a group identifier (G-RNTI), a discontinuous reception configuration (DRX configuration or scheduling information: MTCH transmission ON time, MTCH transmission cycle, reference time and time offset, HARQ retransmission configuration), a layer 2 configuration (PDCP configuration, RLC configuration), and a physical channel configuration (PDCCH configuration, PDSCH configuration, SSB mapping configuration).

(2.2.2) Multicast Reception in RRC Inactive State The UE 100 in the RRC inactive state may receive a multicast session (specifically, MBS data belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as a “new SIB”) from the gNB 200. The new SIB includes a configuration of a newly introduced MCCH (also referred to as a “multicast MCCH”). Second, the UE 100 in the RRC inactive state receives a multicast MCCH based on the new SIB from the gNB 200. The multicast MCCH includes a PTM configuration. The PTM configuration carries a configuration for an MTCH for multicast session reception and a configuration of a multicast MRB which is an MRB for multicast session. Third, the UE 100 in the RRC inactive state receives an MTCH based on the multicast MCCH. The MTCH transmits a multicast session (specifically, MBS data belonging to the multicast session).

When the gNB 200 configures the UE 100 to receive multicast in the RRC inactive state, the gNB 200 can transmit the PTM configuration using an RRC release message including a suspend configuration to the UE 100. In this case, the UE 100, upon receiving the RRC Release message including the PTM configuration from the gNB 200, transitions to the RRC inactive state and receives the multicast session in the RRC inactive state.

The UE 100 in the RRC inactive state performing the multicast reception can reduce a load (resource consumption and/or power consumption) on the network 5 and the UE 100, compared to when the UE 100 in the RRC connected state performs the multicast reception.

### (3) Operation of Mobile Communication System

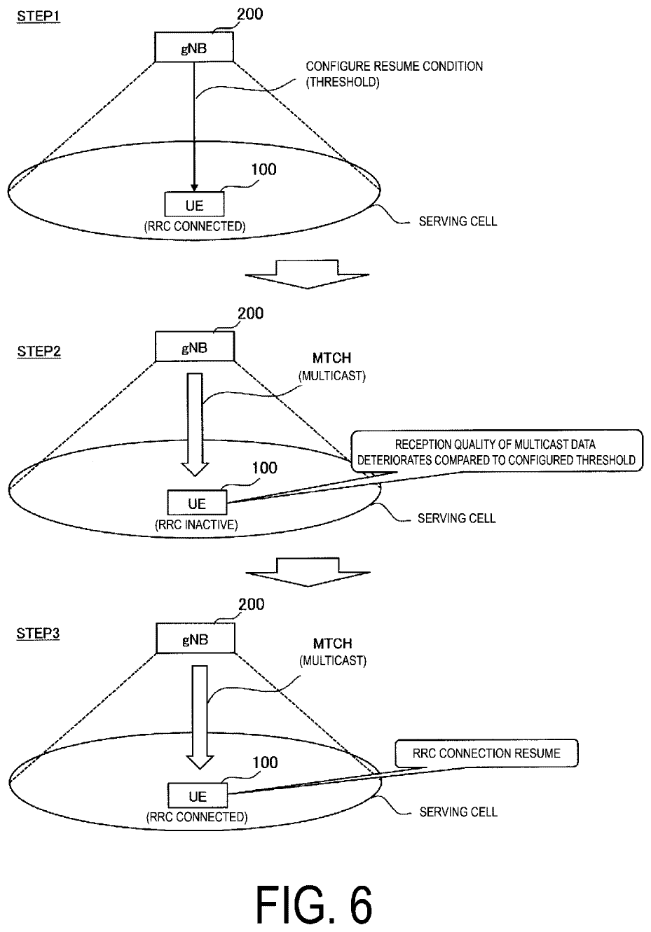

FIG. 6 is a diagram illustrating an operation of the mobile communication system 1 according to the embodiment.

In STEP 1, the gNB 200 transmits a resume condition configuration for configuring the resume condition to the UE 100. The UE 100 receives the resume condition configuration from the gNB 200. In the illustrated example, the gNB 200 transmits the resume condition configuration in dedicated signaling, for example, an RRC Release message or an RRC Reconfiguration message, to the UE 100 in the RRC connected state. However, the gNB 200 may transmit the resume condition configuration in broadcast signaling, for example, an MCCH or an SIB, to the UE 100 in the RRC connected state or the RRC inactive state.

The resume condition configuration includes a threshold to be compared with the multicast data reception quality. The multicast data reception quality may be at least one selected from the group consisting of reference signals received power (RSRP), reference signal received quality (RSRQ), signal-to-interference-plus-noise ratio (SINR), bit error rate (BER), block error rate (BLER), and packet error rate (PER). These reception qualities are preferably reception qualities for the MTCHs carrying the multicast sessions (i.e., multicast data reception qualities). Note that when the UE 100 receives a plurality of multicast sessions, the resume condition may be configured for the UE 100 for each multicast session (for each MBS session ID).

In STEP 2, the UE 100 in the RRC inactive state receives a multicast session (multicast data) on the MTCH from the gNB 200.

Here, in a case where the resume condition configuration is transmitted in the RRC Reconfiguration message from the gNB 200 to the UE 100, the UE 100 after receiving the RRC Reconfiguration message, receives the RRC Release message including the suspend configuration from the gNB 200 to transition to the RRC inactive state, and performs the multicast reception in the RRC inactive state. On the other hand, in a case where the resume condition configuration is transmitted in the RRC Release message from the gNB 200 to the UE 100, the UE 100 receives the RRC Release message from the gNB 200 to transition to the RRC inactive state, and performs the multicast reception in the RRC inactive state.

The UE 100 that performs the multicast reception in the RRC inactive state measures the reception quality of the multicast data (also referred to as “multicast reception quality”), and evaluates whether the multicast reception quality satisfies the resume condition. In a case where the resume condition is configured as an RSRP threshold, an RSRQ threshold, or an SINR threshold, when the multicast reception quality (RSRP, RSRQ, or SINR) falls below the threshold, the UE 100 considers that the multicast reception quality deteriorates compared to the threshold and determines that the multicast reception quality satisfies the resume condition.

On the other hand, in a case where the resume condition is configured as a BER threshold, a BLER threshold, or a PER threshold, when the multicast reception quality (BER, BLER, or PER) is higher than the threshold, the UE 100 considers that the multicast reception quality deteriorates compared to the threshold and determines that the multicast reception quality satisfies the resume condition.

In STEP 3, the UE 100 in the RRC inactive state initiates the RRC connection resume in response to determining that the multicast reception quality satisfies the resume condition. Specifically, the UE 100 transmits an RRC resume request message to the gNB 200 (a current serving cell). Here, the gNB 200 ordinarily receives the RRC Resume Request message and transmits an RRC Resume message to the UE 100. The UE 100 resumes the RRC connection in response to receiving the RRC Release message, and transitions from the RRC inactive state to the RRC connected state. The UE 100 in the RRC connected state, which can use link adaptation and retransmission control, can perform high-quality multicast reception.

According to such a procedure, when the QoS required for multicast reception is not satisfied, the UE 100 can autonomously transition to the RRC connected state through the RRC connection resume, thus facilitating satisfying the QoS required for multicast reception. However, in the current 3GPP technical specifications, the network 5 cannot recognize the situation when the QoS required for multicast reception is not satisfied, and therefore, it is difficult to perform network optimization to keep such a situation from recurring.

In the embodiment, the following operation enables the network 5 to recognize the situation when the QoS required for multicast reception is not satisfied to enable improvement of the QoS of the MBS.

First, the UE 100 in the RRC inactive state upon multicast reception receives, from the network 5 (gNB 200), information for configuring a resume condition (resume condition configuration) for initiating the RRC connection resume, the resume condition being in terms of multicast reception quality. The network 5 (gNB 200) may transmit configuration information indicating whether to hold log information related to the multicast reception together with the resume condition configuration to the UE 100. The UE 100 may hold the log information only when configured to hold the log information. Alternatively, the UE 100 may autonomously hold the log information based on the multicast reception quality satisfying the resume condition even without such an explicit configuration.

Second, the UE 100 in the RRC inactive state upon multicast reception evaluates whether the multicast reception quality satisfies the resume condition.

Third, the UE 100 holds the log information related to the multicast reception based on the multicast reception quality satisfying the resume condition. Here, there exist four patterns of timing for holding the log information as follows.

### First Operation Pattern:

The UE 100 holds the log information when the multicast reception quality satisfies the resume condition.

### Second Operation Pattern:

The UE 100 holds the log information when initiating the RRC connection resume after the multicast reception quality satisfies the resume condition.

### Third Operation Pattern:

The UE 100 holds the log information when succeeding in the RRC connection resume after the multicast reception quality satisfies the resume condition.

### Fourth Operation Pattern:

The UE 100 holds the log information when failing in the RRC connection resume after the multicast reception quality satisfies the resume condition.

The log information includes, for example, at least one selected from the group consisting of the following pieces of information 1) to 7):
1) a measurement result of the multicast reception quality;
2) identification information for identifying the satisfied resume condition;
3) session identification information for identifying the multicast session of which the multicast reception quality satisfies the resume condition;
4) cell identification information for identifying the serving cell of the UE 100 when the multicast reception quality satisfies the resume condition;
5) location information for identifying the geographical location of the UE 100 when the multicast reception quality satisfies the resume condition;
6) time information for identifying a timing at which the multicast reception quality satisfies the resume condition;
7) identification information for identifying whether the RRC connection resume is failed or succeeded.

Fourth, the UE 100 transmits the log information to the network 5 (gNB 200) after transitioning from the RRC inactive state to the RRC connected state.

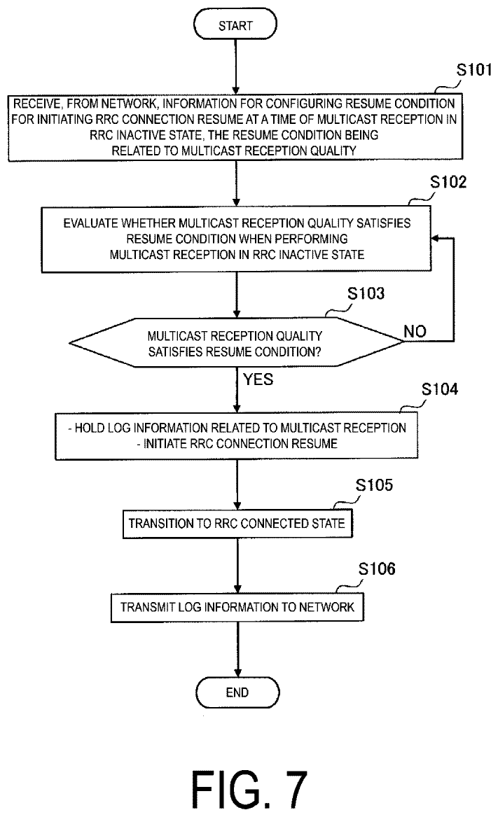

FIG. 7 is a flowchart illustrating an example of the first operation pattern or the second operation pattern of the mobile communication system 1 according to the embodiment.

In step S101, the gNB 200 configures a resume condition for the UE 100. Here, the UE 100 in the RRC inactive state upon multicast reception receives, from the gNB 200, information for configuring a resume condition (resume condition configuration) for initiating the RRC connection resume, the resume condition being in terms of multicast reception quality.

In step S102, the UE 100 receives a multicast session in the RRC inactive state. The UE 100 measures the multicast reception quality when performing the multicast reception in the RRC inactive state, and evaluates whether the multicast reception quality satisfies the resume condition when performing the multicast reception in the RRC inactive state.

If the UE 100 determines that the multicast reception quality satisfies the resume condition (step S103: YES), in step S104, the UE 100 holds the log information related to the multicast reception. The UE 100 initiates the RRC connection resume. The UE 100 may hold the log information before initiating the RRC connection resume. The UE 100 may hold the log information upon initiating the RRC connection resume.

The UE 100 may include, in the log information, for example, the multicast reception qualities (RSRP, RSRQ, SINR, BER, BLER, PER) measured in step S102. The UE 100 may include, in the log information, only items, among these reception quality indicators (RSRP, RSRQ, SINR, BER, BLER, PER), of which thresholds are configured for the resume condition. The UE 100 may include all items in the log information. When a plurality of resume conditions (a plurality of thresholds) are configured for the UE 100, the UE 100 may include, in the log information, cause information indicating which resume condition (which threshold) is satisfied. For example, if the cause is the RSRP falling below the threshold, the UE 100 records that fact.

The UE 100 may include, in the log information, the MBS session ID of the multicast session received in the RRC inactive state. When the UE 100 receives a plurality of multicast sessions in the RRC inactive state and a resume condition is configured for each multicast session, the UE 100 may include, in the log information, only the MBS session ID of the multicast session that satisfies the resume condition. The UE 100 may include the MBS session ID of each of the plurality of multicast sessions in the log information.

The UE 100 may include, in the log information, a cell ID indicating the serving cell of the UE 100 when the multicast reception quality satisfies the resume condition.

The UE 100 may include, in the log information, the location information indicating the geographical location of the UE 100 when the multicast reception quality satisfies the resume condition.

The UE 100 may include, in the log information, the time information (for example, a time stamp) indicating the timing at which the multicast reception quality satisfies the resume condition.

In step S105, the UE 100 transitions to the RRC connected state through the RRC connection resume.

In step S106, the UE 100 transmits the held log information to the network 5 (gNB 200). For example, the UE 100 transmits a log holding indication (Availability Indication) indicating that the log information is held to the network 5. After transmitting the log holding indication, the UE 100 transmits a message (UE Information Response) including the held log information to the network 5 in response to receiving a log transmission request (UE Information Request) from the network 5.

The network 5 may identify a problem occurrence location and a situation based on log information from the UE 100, and optimize a coverage area. The network 5 may change the resume condition (threshold) to be configured for the UE 100 based on the log information from the UE 100. The network 5 may cause another UE 100 that performs multicast reception in the RRC inactive state to transition to the RRC connected state by paging (RAN Paging) based on the log information from the UE 100.

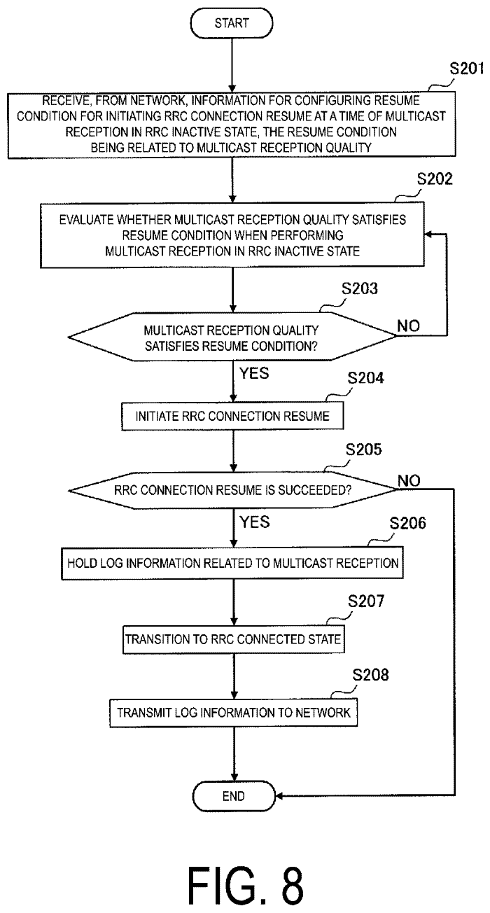

FIG. 8 is a flowchart illustrating an example of the third operation pattern of the mobile communication system 1 according to the embodiment. Here, the difference from the operation of FIG. 7 is described.

The operations in step S201 to step S203 are the same as and/or similar to those of the operations of FIG. 7.

If the UE determines that the multicast reception quality satisfies the resume condition (step S203: YES), in step S204, the UE 100 initiates the RRC connection resume.

In step S205, the UE 100 determines whether the RRC connection resume is succeeded. For example, after transmitting the RRC Resume Request message to the gNB 200, if the UE 100 receives the RRC Resume Request message from the gNB 200, the UE 100 determines that the RRC connection resume is succeeded, otherwise determines that the RRC connection resume is failed.

If determining that the RRC connection resume is succeeded (step S205: YES), in step S206, the UE 100 holds the log information as described above. In this operation pattern, the UE 100 may include, in the log information, information indicating success in the RRC connection resume due to that the multicast reception quality satisfies the resume condition.

In step S207, the UE 100 transitions to the RRC connected state through the RRC connection resume.

In step S208, the UE 100 transmits the held log information to the network 5 (gNB 200).

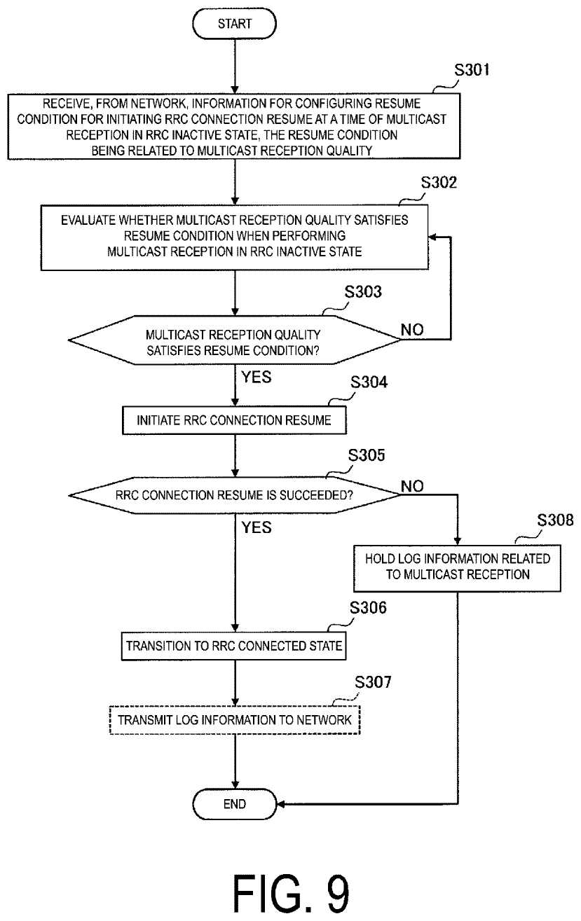

FIG. 9 is a flowchart illustrating an example of the fourth operation pattern of the mobile communication system 1 according to the embodiment. Here, the differences from the operations of FIGS. 7 and 8 are described.

The operations in step S301 to step S303 are the same as and/or similar to those of the operations of FIGS. 7 and 8.

If the UE determines that the multicast reception quality satisfies the resume condition (step S303: YES), in step S304, the UE 100 initiates the RRC connection resume.

In step S305, the UE 100 determines whether the RRC connection resume is succeeded.

If determining that the RRC connection resume is succeeded (step S305: YES), in step S306, the UE 100 transitions to the RRC connected state. Then, in step S307, the UE 100 transmits the log information to the network 5 if the UE 100 holds the log information (gNB 200).

On the other hand, if determining that the RRC connection resume is failed (step S305: NO), in step S308, the UE 100 holds the log information as described above. In this operation pattern, the UE 100 may include, in the log information, information indicating failure in the RRC connection resume due to the multicast reception quality satisfying the resume condition. Thereafter, the UE 100 continues to hold the log information. The UE 100, when transitioning from the RRC idle state or the RRC inactive state to the RRC connected state, may transmit the held log information to the network 5.

### (4) Other Embodiments

The resume condition may be configured in association with each of the serving cell and the neighbor cell from the gNB 200 for the UE 100. The UE 100 may perform the RRC resume only in a case where these two resume conditions are satisfied, and may not need to perform the RRC resume in other cases. For example, in a case where the threshold of the RSRP is the resume condition, when the RSRP of the serving cell falls below the threshold and the RSRP of the neighbor cell falls below the threshold, the RRC resume is performed. Note that these RSRP thresholds may be configured to have different values. Note that the combination of the two resume conditions may be a set targeted to the serving cell and all the neighbor cells, or may be configured differently for each neighbor cell.

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplements

Features relating to the embodiments described above are described below as supplements.

### Supplementary Note 1

A communication method performed by a user equipment in a mobile communication system for providing a multicast/broadcast service (MBS), the communication method including the steps of:
receiving, from a network, information for configuring a resume condition for initiating a radio resource control (RRC) connection resume at a time of multicast reception in an RRC inactive state, the resume condition being related to multicast reception quality;
evaluating whether the multicast reception quality satisfies the resume condition when performing the multicast reception in the RRC inactive state;
holding log information related to the multicast reception based on the multicast reception quality satisfying the resume condition; and
transmitting the log information to the network after transitioning from the RRC inactive state to an RRC connected state.

### Supplementary Note 2

The communication method according to supplementary note 1, wherein the holding comprises holding, by the user equipment, the log information when the multicast reception quality satisfies the resume condition.

### Supplementary Note 3

The communication method according to supplementary note 1, wherein the holding comprises holding, by the user equipment, the log information when initiating the RRC connection resume after the multicast reception quality satisfies the resume condition.

### Supplementary Note 4

The communication method according to supplementary note 1, wherein the holding comprises holding, by the user equipment, the log information when failing or succeeding in the RRC connection resume after the multicast reception quality satisfies the resume condition.

### Supplementary Note 5

The communication method according to any one of supplementary notes 1 to 4, wherein the log information includes a measurement result of the multicast reception quality.

### Supplementary Note 6

The communication method according to any one of supplementary notes 1 to 5, wherein the log information includes identification information for identifying the satisfied resume condition.

### Supplementary Note 7

The communication method according to any one of supplementary notes 1 to 6, wherein the log information includes session identification information for identifying a multicast session of which the multicast reception quality satisfies the resume condition.

### Supplementary Note 8

The communication method according to any one of supplementary notes 1 to 7, wherein the log information includes cell identification information for identifying a serving cell of the user equipment when the multicast reception quality satisfies the resume condition.

### Supplementary Note 9

The communication method according to any one of supplementary notes 1 to 8, wherein the log information includes location information for identifying a geographical location of the user equipment when the multicast reception quality satisfies the resume condition.

### Supplementary Note 10

The communication method according to any one of supplementary notes 1 to 9, wherein the log information includes time information for identifying a timing at which the multicast reception quality satisfies the resume condition.

### Supplementary Note 11

The communication method according to any one of supplementary notes 4 to 10, wherein the log information includes identification information for identifying whether the RRC connection resume is failed or succeeded.

### Supplementary Note 12

A user equipment used in a mobile communication system for providing a multicast/broadcast service (MBS), the user equipment including:
a receiver configured to receive, from a network, information for configuring a resume condition for initiating a radio resource control (RRC) connection resume at a time of multicast reception in an RRC inactive state, the resume condition being related to multicast reception quality;
a controller configured to evaluate whether the multicast reception quality satisfies the resume condition when performing the multicast reception in the RRC inactive state, and hold log information related to the multicast reception based on the multicast reception quality satisfying the resume condition; and
a transmitter configured to transmit the log information to the network after transitioning from the RRC inactive state to an RRC connected state.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method performed by a user equipment in a mobile communication system for providing a multicast/broadcast service (MBS), the communication method comprising:
receiving, from a network node, information for configuring a resume condition for initiating a radio resource control (RRC) connection resume at a time of multicast reception in an RRC inactive state, the resume condition being related to multicast reception quality;
evaluating whether the multicast reception quality satisfies the resume condition when performing the multicast reception in the RRC inactive state;
holding log information related to the multicast reception based on the multicast reception quality satisfying the resume condition; and
transmitting the log information to the network node after transitioning from the RRC inactive state to an RRC connected state.

2. The communication method according to claim 1, wherein
the holding comprises holding, by the user equipment, the log information when the multicast reception quality satisfies the resume condition.

3. The communication method according to claim 1, wherein
the holding comprises holding, by the user equipment, the log information when initiating the RRC connection resume after the multicast reception quality satisfies the resume condition.

4. The communication method according to claim 1, wherein
the holding comprises holding, by the user equipment, the log information when failing or succeeding in the RRC connection resume after the multicast reception quality satisfies the resume condition.

5. The communication method according to claim 1, wherein
the log information comprises a measurement result of the multicast reception quality.

6. The communication method according to claim 1, wherein
the log information comprises identification information for identifying the satisfied resume condition.

7. The communication method according to claim 1, wherein
the log information comprises session identification information for identifying a multicast session of which the multicast reception quality satisfies the resume condition.

8. The communication method according to claim 1, wherein
the log information comprises cell identification information for identifying a serving cell of the user equipment when the multicast reception quality satisfies the resume condition.

9. The communication method according to claim 1, wherein
the log information comprises location information for identifying a geographical location of the user equipment when the multicast reception quality satisfies the resume condition.

10. The communication method according to claim 1, wherein
the log information comprises time information for identifying a timing at which the multicast reception quality satisfies the resume condition.

11. The communication method according to claim 4, wherein
the log information comprises identification information for identifying whether the RRC connection resume is failed or succeeded.

12. A user equipment used in a mobile communication system for providing a multicast/broadcast service (MBS), the user equipment comprising:
a receiver configured to receive, from a network node, information for configuring a resume condition for initiating a radio resource control (RRC) connection resume at a time of multicast reception in an RRC inactive state, the resume condition being related to multicast reception quality;
a controller configured to evaluate whether the multicast reception quality satisfies the resume condition when performing the multicast reception in the RRC inactive state, and hold log information related to the multicast reception based on the multicast reception quality satisfying the resume condition; and
a transmitter configured to transmit the log information to the network node after transitioning from the RRC inactive state to an RRC connected state.
